(19) United States
(12) Patent Application Publication
(10) Pub. No.: US 2023/0060323 A1
(43) Pub. Date: Mar. 2, 2023

(54) HOW TO CONFUSE ADVERSARIAL ENVIRONMENT MAPPING TOOLS

(71) Applicant: ILLUSIVE NETWORKS LTD., Tel Aviv (IL)

(72) Inventors: Yan Linkov, Ramat Gan (IL); Tom Sela, Tel Aviv (IL)

(21) Appl. No.: 17/705,327

(22) Filed: Mar. 27, 2022

Related U.S. Application Data
(60) Provisional application No. 63/233,759, filed on Aug. 17, 2021.

(51) Int. Cl. H04L 9/40

(52) U.S. Cl. CPC H04L 63/1491

(57) ABSTRACT

A method for protecting a computer network against attackers, including receiving requests, initiated by a network scanner, for local network scans and, in response to the receiving, provide responses including deceptive data indicative of a short attack path to a target computer, wherein the attack path traverses a controlled computer that is used to detect network attacks.

### FIELD OF THE INVENTION

The present invention relates to computer security, and in particular to protection against adversarial computer network mapping tools.

### BACKGROUND OF THE INVENTION

Reference is made to FIG. 1, which is a simplified diagram of a prior art enterprise network 100 connected to an external Internet 10. Network 100 is shown generally with resources including computers 110, databases 120, and switches and routers 130, although it will be appreciated by those skilled in the art that enterprise networks today are generally much more complex and include other devices such as mobile devices including smart phones and tablets, printers, other types of network elements such as relays, and Internet of Things objects. The various connections shown in FIG. 1 may be direct or indirect, wired or wireless communications, or a combination of wired and wireless connections. Computers 110 and databases 120 may be physical elements or logical elements, or a mix of physical and logical elements. Computers 110 and databases 120 may be virtual machines. Computer 110 and databases 120 may be local, remote or cloud-based elements, or a mix of local, remote and cloud-based elements. Computers 110 may be client workstation computers, or server computers including inter glia file transfer protocol (FTP) servers, email servers, structured query language (SQL) servers, secure shell (SSH) servers and other application servers, or a mix of client and server computers. A corporate information technology (IT) department manages and controls network 100 in order to serve the corporate requirements and meet the corporate needs.

Access to computers 110 and servers 120 in network 100 is governed by a directory service 140, that authorizes users to access computers 110 and databases 120 based on “credentials”. Directory service 140 is preferably a name directory, such as ACTIVE DIRECTORY® (AD) developed by Microsoft Corporation of Redmond, Wash., for WINDOWS® environments. Background information about AD is available at Wikipedia. Other directory services for WINDOWS and non-WINDOWS environments, include inter alia Lightweight Directory Access Protocol (LDAP), Remote Authentication Dial-In User Service (RADIUS), and Apple Filing Protocol (AFP), formerly APPLETALK®, developed by Apple Inc. of Cupertino, Calif. Background information about LDAP, RADIUS and AFP is available at Wikipedia.

Active Directory 140 may be one or more local machine access controllers. Active Directory 140 may be one or more authorization servers, such as a database server or an application server.

Credentials for accessing computers 110 and databases 120 include inter alia server account credentials such as <address> <username> <password> for an FTP server, an SQL server, or an SSH server. Credentials for accessing computers 110 and databases 120 also include user login credentials <username> <password>, or <username> <ticket>, where “ticket” is an authentication ticket, such as a ticket for the Kerberos authentication protocol or NTLM hash used by Microsoft Corp., or login credentials via certificates or via another implementation used today or in the future. Background information about the Kerberos protocol and the LM hash is available at Wikipedia.

Active Directory 140 maintains a directory of computers 110, databases 120 and their users. Active Directory 140 authorizes users and computers, assigns and enforces security policies, and installs and updates software. When a user logs into a computer 110, Active Directory 140 checks the submitted password, and determines if the user is an administrator (admin), a normal user (user) or another user type.

Network 100 may include a domain name system (DNS) server 150, or such other name service system, for translating domain names to IP addresses. Background information about DNS is available at Wikipedia.

One of the most prominent threats that organizations face is a targeted attack; i.e., an individual or group of individuals that attacks the organization for a specific purpose, such as stealing data, using data and systems, modifying data and systems, and sabotaging data and systems. Targeted attacks are carried out in multiple stages, typically including inter alia reconnaissance, penetration, lateral movement and payload. Lateral movement involves orientation, movement and propagation, and includes establishing a foothold within the organization and expanding that foothold to additional systems within the organization.

In order to carry out the lateral movement stage, an attacker, whether a human being who is operating a network scanner within the organization's network, or a tool with “learning” capabilities, learns information about the environment it is operating in, such as network topology and organization structure, learns “where can I go from my current step” and “how can I go from my current step (privileged required)”, and learns implemented security solutions, and then operates in accordance with that data.

An advanced attacker nay use different attack techniques to enter a corporate network and to move laterally within the network in order to obtain the attacker's resource goals. The advanced attacker may begin with a workstation, server or any other network entity to start his lateral movement. He uses different methods to enter the first network node, including inter alia social engineering, existing exploit and/or vulnerability that he knows to exercise, and a Trojan horse or any other malware allowing him to control the first node.

Reference is made to FIG. 2, which is a simplified diagram of enterprise network 100 with attack vectors of an attacker at an early stage of lateral movement. Once an attacker has taken control of a first node in a corporate network, he uses different advanced attack techniques for orientation and propagation and discovery of additional ways to reach other network nodes in the corporate network. Attacker movement from node to node is performed via an “attack vector”, which is an object in memory or storage of a first computer that may be used to access a second computer.

Exemplary attack vectors include inter alia credentials of users with enhanced privileges, existing share names on different servers, and details of an FTP server, an email server, an SQL server or an SSH server and its credentials. Attack vectors are often available to an attacker because a user did not logoff his workstation or clear his cache. E.g., if a user contacted a help desk and gave the help desk remote access to his workstation and did not logoff his workstation, then the help desk access credentials may still be stored in the user's local cache and available to the attacker. Similarly, if the user accessed an FTP server, then the FTP account login parameters may be stored in the user's local cache or profile and available to the attacker.

Attack vectors enable inter alia a move from workstation A server B based on a shared name and its credentials, connection to a different workstation using local admin credentials that reside on a current workstation, and connection to an FTP server using specific access credentials.

Attack vectors include inter alia:

user credentials of the form <username> <password>
user credentials of the form <username> <hash of password>
user credentials of the form <username> <ticket>
FTP server credentials of the form <address> <username> <password>
SSH server credentials of the form <address> <username> <password>

Attack vectors may be categorized by families, such as inter alia

F1—user credentials
F2—connections
F3—FTP logins
F4—SSH logins
F5—share names
F6—databases
F7—network devices

### F8—URLs

### F9—Remote Desktop Protocol (RDP)

F10—recent command
F11—scanners

Credentials for a computer B that reside on a computer A provide an attack vector for an attacker from computer A →computer B.

Reference is made to FIG. 3, which is a simplified diagram of enterprise network 100 with attack paths of an attacker at a later stage of lateral movement. Whereas IT “sees” the logical and physical network topology, an attacker that lands on the first network node “sees” attack vectors that depart from that node and move laterally to other nodes. The attacker can move to such nodes and then follow “attack paths” by successively discovering attack vectors from node to node.

When the attacker implements such a discovery process on all nodes in the network, he will be able to “see” all attack vectors of the corporate network and generate a “maximal attack map”. Before the attacker discovers all attack vectors on network nodes and completes the discovery process, he generates a “current attack map” that is currently available to him.

An objective of the attacker is to discover an attack path that leads him to a target network node. The target may be a bank authorized server that is used by the corporation for ordering bank account transfers of money, it may be an FTP server that updates the image of all corporate points of sale, it may be a server or workstation that stores confidential information such as source code and secret formulas of the corporation, or it may be any other network node that is of value to the attacker and is his “attack goal node”.

When the attacker lands on the first node, but does not know how to reach the attack go& node, he generates a current attack map that leads to the attack goal node.

A familiar tool for network mapping used by attackers is BloodHound/SharpHound. BloodHound/Sharphound scans a network and provides an attacker with paths to high value targets. Specifically, BloodHound is an AD reconnaissance graphical user interface that reveals hidden relationships and identifies attack paths within an AD environment. SharpHound is a data collector for BloodHound. SharpHound is written in C# and uses native Windows API functions and LDAP namespace functions to collect data from domain controllers and domain-joined Windows systems. The attacker relies on this information in order to focus his efforts on attacking network hosts which will lead him to the high value target he pursues.

Reference is made to FIG. 4, which is a prior art table of a Sharphound collection (“cheat”) sheet.

Current methods of protection try to detect scans, such as Bloodhound scans, by means of network monitoring. One method to defend against such attacks, termed “honeypots”, is to plant and monitor misleading information/decoys/bait, with the objective of the attacker learning of their existence and then consuming those bait resources, and to notify an administrator of the malicious activity. Background information about honeypots is available at Wikipedia.

Conventional honeypot systems operate by monitoring access to a supervised element in a computer network. Access monitoring generates many false alerts, caused by non-malicious access from automatic monitoring systems and by user mistakes.

### SUMMARY

Embodiments of the present invention provide an “inverse” to conventional approaches, by use of trap servers that respond to a network scanner with coordinated deceptive responses. The responses deceive the network scanner into identifying a short attack path to a high value target, where the path traverses a controlled computer. Thus instead of working on the local attack vector level, embodiments of the subject invention identify attractive/short attack paths to target computers that traverse a controlled computer, such as a trap server, and generate responses to a network scanner's queries in such a way that the scanner identifies these paths, and displays them to an attacker. As such, these embodiments both divert an attacker from bona fide attack paths, and enable detection of the attacker.

There is thus provided in accordance with an embodiment of the present invention a method for protecting a computer network against attackers, including receiving requests, initiated by a network scanner, for local network scans and, in response to the receiving, provide responses including deceptive data indicative of a short attack path to a target computer, wherein the attack path traverses a controlled computer that is used to detect network attacks.

There is additionally provided in accordance with an embodiment of the present invention a computer server within a network including at least one memory storing program code with instructions that cause the computer server to receive requests, initiated by a network scanner, for local network scans and, in response to the receiving, provide responses including deceptive data indicative of a short attack path to a target computer, wherein the attack path traverses a controlled computer that is used to detect network attacks.

### BRIEF DESCRIPTION OF THE DRAWINGS

The present invention will be more fully understood and appreciated from the following detailed description, taken in conjunction with the drawings in which:

FIG. 1 is a simplified diagram of a prior art enterprise network connected to an external Internet;

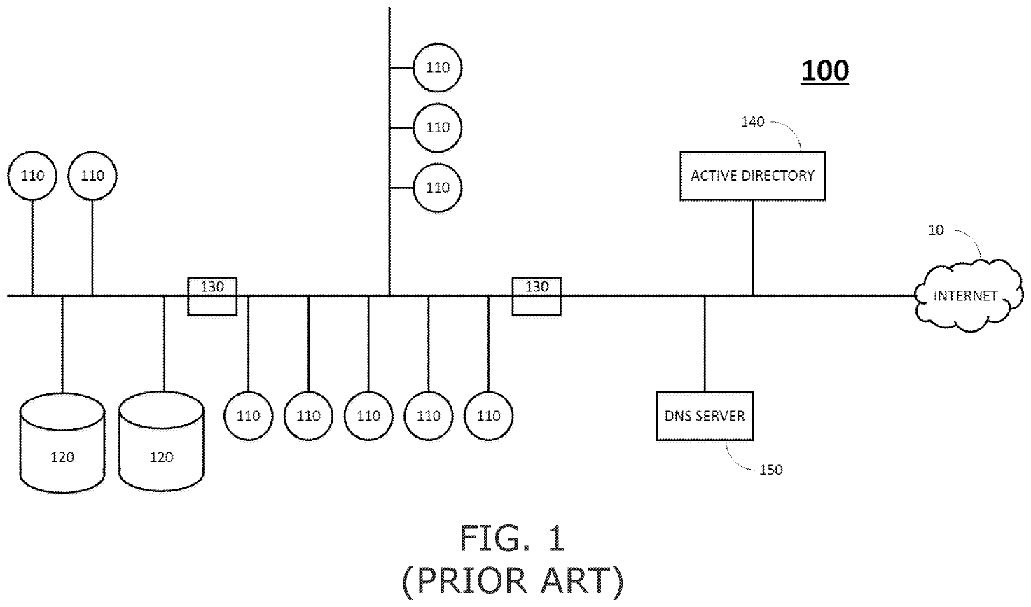

FIG. 2 is a simplified diagram of a prior art enterprise network with attack vectors of an attacker at an early stage of lateral movement;

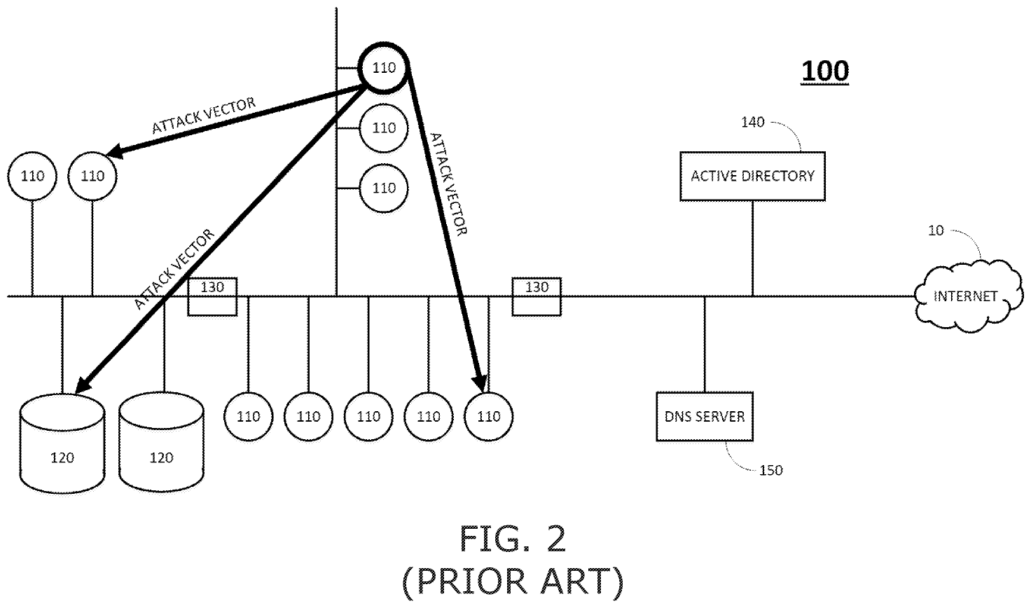

FIG. 3 is a simplified diagram of a prior art enterprise network with attack paths of an attacker at a later stage of lateral movement;

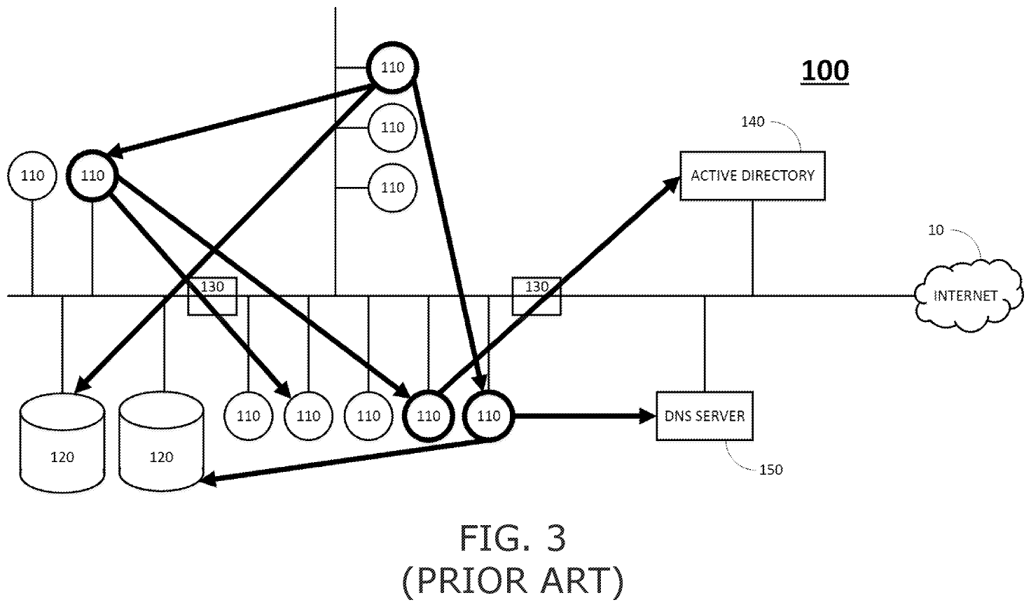

FIG. 4 is a prior art table of a Sharphound collection (“cheat”) sheet;

FIG. 5 is a simplified diagram of an enterprise network with network surveillance, in accordance with an embodiment of the present invention;

FIG. 6 is a simplified flowchart of a method for confusing an adversarial environment mapping tool, such as Bloodhound/Sharphound, in accordance with an embodiment of the present invention;

FIG. 7 is a simplified diagram of prior art results of a network scanner used to scan a network and provide the attacker with attack paths to high value targets;

FIG. 8 is a simplified diagram of results of confusing a network scanner to provide an attacker with deceptive relatively short attack paths that lead to high value targets through a controlled sever, using the method of FIG. 6, in accordance with an embodiment of the present invention; and

FIG. 9 is a simplified drawing of implementation details for generating a deceptive network scan using the MS RRP protocol, such as the deceptive network scan shown in FIG. 8, in response to requests from network scanners, in accordance with an embodiment of the present invention.

For reference to the figures, the following index of elements and their numerals is provided. Similarly numbered elements represent elements of the same type, but they need not be identical elements.

TABLE I
Elements in the figures

| Element | Description |
|---|---|
| 10 | Internet |
| 100 | enterprise network |
| 110 | network computers |
| 111 | specific workstation |
| 112 | specific computer server |
| 120 | network databases |
| 130 | network switches and routers |
| 140 | Active Directory |
| 150 | DNS server |
| 200 | enterprise network with network surveillance |
| 210 | deception management server |
| 220 | trap servers |
| 221 | specific trap server |

Elements numbered in the 1000's are operations of flow charts.

### DETAILED DESCRIPTION

In accordance with embodiments of the present invention, systems and methods are provided for deceiving adversarial network scanners. These systems and methods generate decoy responses that indicate short attack path(s) to target computer(s), wherein the attack path(s) traverse controlled computer(s) that are used to detect network attacks.

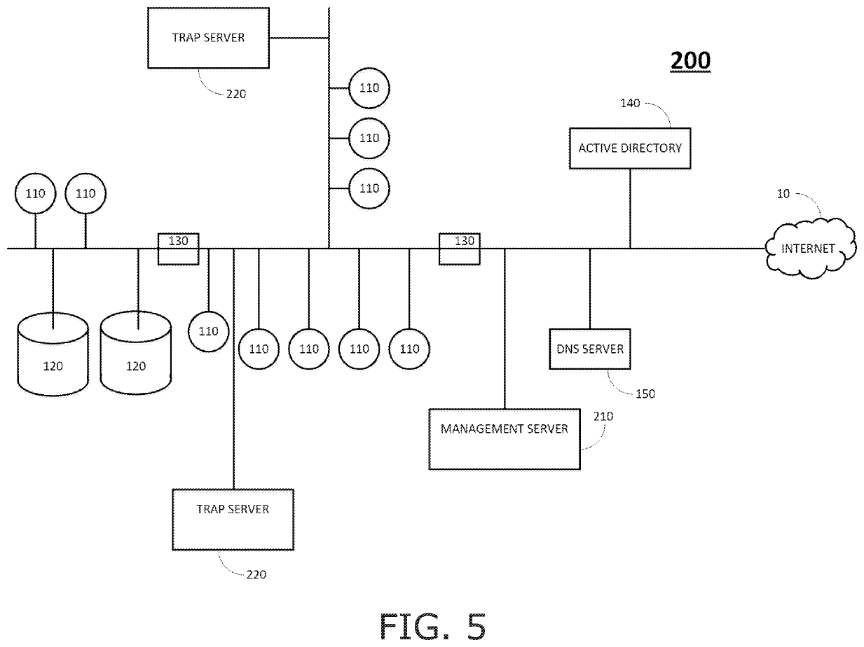

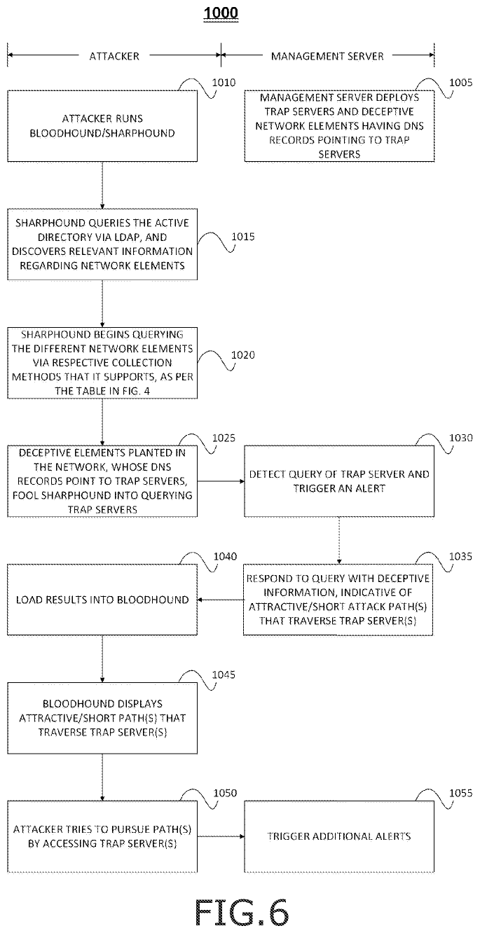

Reference is made to FIG. 5, which is a simplified diagram of an enterprise network 200 with network surveillance, in accordance with an embodiment of the present invention. Network 200 includes a deception management server 210 and trap servers 220. Deception management server 210 provides responses to queries initiated by network scanners, the responses indicative of short attack path(s) to target computer(s), where the paths traverse trap servers 220. Operation of deception management server 210 is described hereinbelow with reference to FIG. 6.

Once an attacker is detected, a “response procedure” is launched. The response procedure includes inter alia various notifications to various addresses, and actions on a trap server such as launching an investigation process, and isolating, shutting down and re-imaging one or more network nodes. The response procedure collects information available on one or more nodes that may help in identifying the attacker's acts, attention and progress.

Notification servers (not shown) are notified when an attacker enters a trap server. The notification servers may discover this by themselves, or by using information stored on Active Directory 140. The notification servers forward notifications, or results of processing multiple notifications, to create notification time lines or such other analytics.

### Confusing a Network Scanner

Embodiments of the present invention use servers that respond to a network scanner with coordinated deceptive responses. The responses deceive the network scanner into identifying a short attack path to a high value target, where the path traverses a controlled computer

Reference is made to FIG. 6, which is a simplified flowchart of a method 1000 for confusing an adversarial network scanner, such as Bloodhound/Sharphound, in accordance with an embodiment of the present invention. The flowchart of FIG. 6 is divided into two columns. The left column includes operations performed by an attacker who uses a network scanner such as Bloodhound/Sharphound. The right column includes operations performed by management server 210.

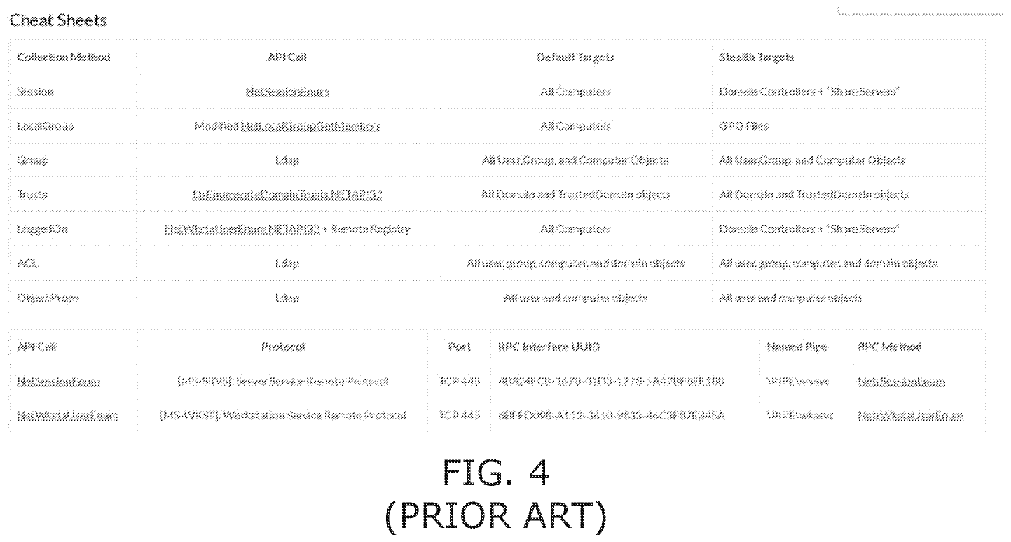

At operation 1005, management server 210 deploys trap servers 220 and deceptive network elements having DNS records pointing to the trap servers 220. At operation 1010, the attacker runs a network scanner, such as Bloodhound/Sharphound. At operation 1015, Sharphound queries active directory 140 via LDAP, and discovers relevant information regarding elements of network 200. At operation 1020, Sharphound begins querying the different network elements discovered at operation 1015, via respective collection methods that Sharphound supports, as per the table in FIG. 4. At operation 1025, Sharphound is fooled into entering trap servers 220, by the deceptive elements planted in elements of network 200 at operation 1005.

At operation 1030, management server 210 detects querying of one or more trap servers 220, and triggers an alert to an administrator of network 200. At operation 1035, management server instructs the one or more trap servers 220 to respond to the queries with deceptive results, indicative of attractive/short attack path(s) to target computer(s), that traverse trap server(s).

At operation 1040, the deceptive results in the responses are loaded into Bloodhound. At operation 1045, Bloodhound displays to the attacker the attractive/short network path(s) that traverse trap server(s) 220, based on the responses received at operation 1035. At operation 1050, the attacker tries to pursue the attractive/short network path(s) by accessing the trap servers 220. Finally, at operation 1055, management server 210 triggers additional administrative alerts.

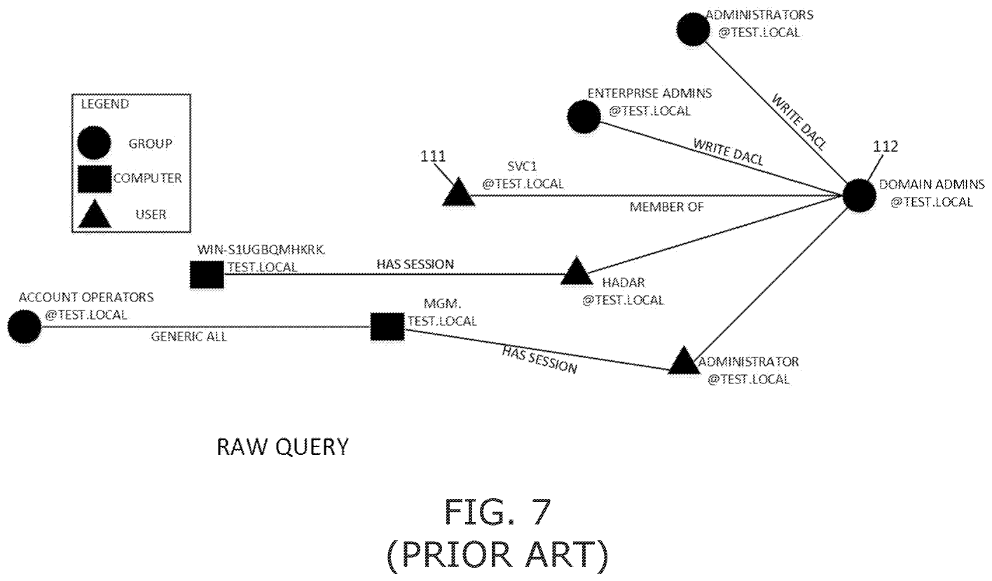

Reference is made to FIG. 7, which is a simplified diagram of prior art results of a network scanner used to scan a network and provide the attacker with attack paths to high value targets, in accordance with an embodiment of the present invention.

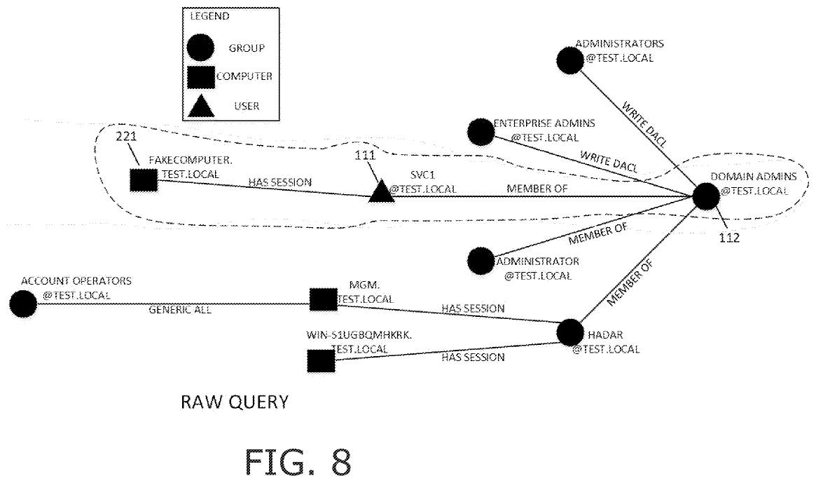

Reference is made to FIG. 8, which is a simplified diagram of results of confusing a network scanner to provide an attacker with deceptive relatively short attack paths that lead to high value targets through a controlled sever, using the method of FIG. 6, in accordance with an embodiment of the present invention. FIG. 8 shows how the results of the network scanner appear after deceptions introduce an attractive deceptive path to a high value target through a trap server.

The deceptive path in FIG. 8 includes a device whose local administrator is in the “domain users” group; i.e., a default group including each member of the domain, with a user (SVC1) who is a member of a “domain admins” group logged on to server computer 112, which is a high value target, from the user's network workstation 111. As such, the attacker is lured into connecting to trap server 221 in order to compromise the credentials of SVC1. However, the deceptive path does not really exist. The deceptive path is based on the deceptive responses provided to the network scanner.

### Implementation Details

Embodiments of the present invention provide coordinated deceptive responses to a network scanner by responding to protocol queries, such as SharpHound queries, with deceptive information. The protocols include MS-WKST, MS-SRVS, MS-RRP, MS-SAMR, MS-LSAD, MS-LST, which are based on the MS-RPCE protocol. The protocols use RPC over Named Pipes protocol sequence, implemented over SMB.

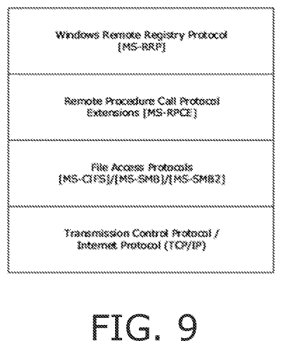

Reference is made to FIG. 9, which is a simplified drawing of implementation details for generating a deceptive network scan using the MS RRP protocol, such as the deceptive network scan shown in FIG. 8, in response to requests from network scanners, in accordance with an embodiment of the present invention.

In the foregoing specification, the invention has been described with reference to specific exemplary embodiments thereof. It will, however, be evident that various modifications and changes may be made to the specific exemplary embodiments without departing from the broader spirit and scope of the invention. Accordingly, the specification and drawings are to be regarded in an illustrative rather than a restrictive sense.

What is claimed is:

1. A method for protecting a computer network against attackers, comprising:
receiving requests, initiated by a network scanner, for local network scans; and
in response to said receiving, provide responses comprising deceptive data indicative of a short attack path to a target computer, wherein the attack path traverses a controlled computer that is used to detect network attacks.

2. The method of claim 1, wherein the controlled computer is a deceptive trap server.

3. A computer server within a network comprising at least one memory storing program code with instructions that cause the computer server to:
receive requests, initiated by a network scanner, for local network scans; and
in response to the receiving, provide responses comprising deceptive data indicative of a short attack path to a target computer, wherein the attack path traverses a controlled computer that is used to detect network attacks.

4. The computer server of claim 3, wherein the controlled computer is a deceptive trap server.
